(19) United States
(12) Patent Application Publication
(10) Pub. No.: US 2024/0409781 A1
(43) Pub. Date: Dec. 12, 2024

(54) PHOTOTHERMAL SWITCHABLE ADHESIVE

(71) Applicant: Nanyang Technological University, Singapore (SG)

(72) Inventors: Matthew Wei Ming TAN, Singapore (SG); Pooi See LEE, Singapore (SG)

(21) Appl. No.: 18/698,078

(22) PCT Filed: Oct. 11, 2022
(86) PCT No.: PCT/SG2022/050723

§ 371 Date: Apr. 3, 2024

(30) Foreign Application Priority Data
Oct. 13, 2021 (SG) 10202111389X

(51) Int. Cl. C09J 7/35; C09J 5/06; C09J 11/04

(52) U.S. Cl. CPC C09J 7/35; C09J 5/06; C09J 11/04; C09J 2301/408; C09J 2301/416; C09J 2301/502

(57) ABSTRACT

Disclosed herein is a photothermal adhesive that has a crosslinked polymeric matrix and a photothermal agent dispersed within the crosslinked polymeric matrix, where the crosslinked polymeric matrix is formed by the random block copolymerisation of: a urethane acrylate polymeric material that has two or more acrylate end groups; and a polymeric or oligomeric crosslinker material having two or more acrylate end groups. Also disclosed herein is a method of manufacturing the photothermal adhesive, uses thereof, and methods of use thereof.

### FIELD OF INVENTION

This invention relates to a reversible adhesive that can be activated through illumination with light and the fabrication thereof. The adhesive strength can be tuned by varying the number of chemical crosslinks. Photothermal effects for adhesion release are derived from dispersed photothermal agents within the adhesive.

### Background

The listing or discussion of a prior-published document in this specification should not necessarily be taken as an acknowledgement that the document is part of the state of the art or is common general knowledge.

Adhesives play a fundamental role in our everyday life and industries, taking various forms from “superglue” to sticky tapes. Generally, these adhesives can be categorized as permanent or temporary; at which the former display high adhesive forces with minimal reusability (e.g. Epoxies) while the latter have lower adhesive forces but can be easily removed (e.g. pressure sensitive tapes). However, given the growing industrial demands such as for increased automated systems, switchable adhesives have been designed to bond and de-bond in response to an external trigger. While various triggers such as electrical and magnetic stimuli have been utilized, photoirradiation presents an attractive means to achieve adhesive switching owing to its contactless stimulation that can be spatially controlled. Furthermore, irradiation wavelength, intensity and time can be tuned to control the adhesive switching performance. However, one of the main challenges faced in the design of adhesives is the force required to remove the adhesive from the substrate. This critical force is dependent on the interfacial strength, contact area and the compliance.

Therefore, there exists a need to discover photothermal adhesive that can achieve adhesive switching.

### SUMMARY OF INVENTION

Aspects and embodiments of the invention will now be discussed by reference to the following numbered clauses.

1. A photothermal adhesive comprising:
a crosslinked polymeric matrix formed by the random block copolymerisation of:
   a urethane acrylate polymeric material that has two or more acrylate end groups; and
   a polymeric or oligomeric crosslinker material having two or more acrylate end groups; and
a photothermal agent, wherein the photothermal agent is dispersed within the crosslinked polymeric matrix.

2. The photothermal adhesive according to Clause 1, wherein the photothermal agent is capable of absorbing light for heat generation to bring about adhesive release through thermal expansion and/or ablation.

3. The photothermal adhesive according to Clause 2, wherein the photothermal agent is selected from one of more of the group consisting of a UV-absorbing photothermal agent, and more particularly, a multiwalled carbon nanotube (MWCNT), a single walled carbon nanotube (SWCNT), an MXene, a graphite, a graphene oxide, a liquid metal, and a carbon black, optionally wherein the photothermal agent is 2-(2H-benzotriazol-2-yl)-4,6-ditertpentylphenol (BZT) or, more particularly, a MWCNT.

4. The photothermal adhesive according to any one of the preceding clauses, wherein wherein the photothermal agent is present in the photothermal adhesive in an amount of from 0.1 to 10 wt % relative to the total weight of the photothermal adhesive, such as from 1 to 5 wt %.

5. The photothermal adhesive according to any one of the preceding clauses, wherein wherein the urethane acrylate polymeric material that has two or more acrylate end groups is an aliphatic acrylate polymeric material that has two acrylate end groups.

6. The photothermal adhesive according to Clause 5, wherein the aliphatic acrylate polymeric material that has two acrylate end groups is selected from one or more of CN310, CN8881, CN8884, CN8888, CN9004, CN9014, CN9028, CN9031, CN9002, CN966J75, CN9018, CN9021, CN3108, CN3211 and CN8004.

7. The photothermal adhesive according to Clause 6, wherein the aliphatic acrylate polymeric material that has two acrylate end groups is CN9021.

8. The photothermal adhesive according to any one of the preceding clauses, wherein the urethane acrylate polymeric material that has two or more acrylate end groups has a number average molecular weight of greater than 20,000 Daltons, such as from 20,001 to 50,000 Daltons.

9. The photothermal adhesive according to any one of the preceding clauses, wherein the polymeric or oligomeric crosslinker material having two or more acrylate end groups is selected from one or more of 1,6-hexanediol diacrylate, tetra(ethylene glycol) diacrylate, or more particularly, poly(trimethylolpropane triacrylate-co-ethylene dimethacrylate), poly(ethyleneglycol) diacrylate (PEGDA), poly(caprolactone) dimethacrylate and poly(propylene glycol) dimethacrylate.

10. The photothermal adhesive according to Clause 9, wherein the polymeric or oligomeric crosslinker material having two or more acrylate end groups is poly(ethyleneglycol) diacrylate (PEGDA).

11. The photothermal adhesive according to any one of the preceding clauses, wherein the polymeric or oligomeric crosslinker material having two or more acrylate end groups has a number average molecular weight of from 200 to 1,000 Daltons.

12. The photothermal adhesive according to Clause 11, wherein the polymeric or oligomeric crosslinker material having two or more acrylate end groups has a number average molecular weight of from 250 to 750 Daltons, such as from 400 to 600 Daltons, such as 575 Daltons.

13. The photothermal adhesive according to any one of the preceding clauses, wherein the polymeric or oligomeric crosslinker material having two or more acrylate end groups is present in an amount of from 5 to 30 wt %, such as from 10 to 20 wt % relative to the total weight of the crosslinked polymeric matrix.

14. The photothermal adhesive according to any one of the preceding clauses, wherein the photothermal adhesive is provided in the form of a film and/or the photothermal adhesive is transparent.

15. A method of forming a photothermal adhesive according to any one of Clauses 1 to 14, the method comprising the steps of:
(a) providing a mixture comprising:
   a urethane acrylate polymeric material that has two or more acrylate end groups; and
   a polymeric or oligomeric crosslinker material having two or more acrylate end groups;
   a photothermal agent; and
   a radical initiator;
(b) heating the mixture at a temperature of from 50 to 100° C. for a period of time to provide the photothermal adhesive.

16. The method according to Clause 15, wherein the temperature is from 70 to 90° C. and/or the period of time is from 15 minutes to 1 hour, such as from 30 to 45 minutes.

17. The method according to Clause 15 or Clause 16, wherein the polymerisation occurs in a vessel without exposure to the ambient atmospheric conditions, optionally wherein the vessel is an enclosed mould.

18. Use of a photothermal adhesive according to any one of Clauses 1 to 14 in a pick and place operation of an object, optionally wherein the object is in the micrometer or millimetre scale.

19. A method of picking and placing an object, the method comprising:
(i) adhering an object to be placed to a film of a photothermal adhesive, where the photothermal adhesive is as described in any one of Clauses 1 to 14 to form an adhered object; and
(ii) placing the adhered object at a desired site and releasing the object from the film of photothermal adhesive by applying light from a light source to the film, thereby causing thermal expansion or ablation of the film to effect release of the adhered object, optionally wherein the object is in the micrometer or millimetre scale.

20. The method according to Clause 19, wherein the light source is an IR laser light source having a wavelength of from 500 to 1,080 nm or a laser having a wavelength of less than 500 nm, such as 488 nm, provided that the photothermal agent is selected from one of more of the group consisting of a multiwalled carbon nanotube (MWCNT), a single walled carbon nanotube (SWCNT), an MXene, a graphite, a graphene oxide, a liquid metal, and a carbon black.

21. The method according to Clause 20, wherein the IR laser light source having a wavelength of from 500 to 1,080 nm or the laser having a wavelength of less than 500 nm, such as 488 or such as 355 nm has a pulse energy of from greater than 0 to 500 μJ.

22. The method according to Clause 19, wherein the light source is an UV light source having a wavelength of from 10 to 400 nm or a laser having a wavelength of less than 400 nm, such as 200 nm, provided that the photothermal agent is a UV-absorbing photothermal agent, optionally wherein the photothermal agent is selected from one or both of 4-phenylazophenol and, more particularly, 2-(2H-benzotriazol-2-yl)-4,6-ditertpentylphenol

23. The method according to Clause 22, wherein the UV laser light source having a wavelength of from 10 to 400 nm or the laser having a wavelength of less than 400 nm, such as 200 nm has a pulse energy of from greater than 0 to 500 μJ.

### DRAWINGS

FIG. 1 depicts the 180° peel test. (a) Schematic of peel test performed; (b) Peel test experiment on polyethylene terephthalate (PET) substrate. CN9021-polyethylene glycol diacrylate (PEGDA) films were attached to red acrylic sheet to reduce films from being stretched during peel off; and (c) Dependence of peel force with PEGDA concentration.

FIG. 2 depicts the ultraviolet-visible (UV-vis) absorbance spectra of CN9021-PEGDA15 with different content of MWCNT from 300 to 1100 nm.

FIG. 3 depicts the temperature changes of CN9021-PEGDA15 and CN9021-PEGDA15/MWCNT1% after IR illumination of 500 to 1080 nm.

FIG. 4 depicts the thermogravimetric analysis (TGA) of CN9021-PEGDA15 with different concentrations of MWCNT (0, 1, 5, and 10 wt %).

FIG. 5 depicts the UV-vis absorbance spectra of CN9021-PEGDA15 with different content of BZT (0, 1, and 10 wt %) from 300 to 2500 nm.

FIG. 6 depicts the temperature changes of CN9021-PEGDA15, CN9021-PEGDA15/BZT1% and CN9021-PEGDA15/BZT10% after UV illumination at 395 nm.

FIG. 7 depicts (a) the schematic of the procedure to pick the object; and (b) the pick up criteria to determine the suitability of the adhesive. A glass slide was used as the control sample.

FIG. 8 depicts the schematic of pick and release using infrared (IR) light.

FIG. 9 depicts the bottom view of the release of silicon pieces during IR illumination. (a) Silicon piece is adhered to CN9021-PEGDA20/MWCNT1%; (b) IR light illumination at 0 s; and (c) Silicon piece falls towards camera after 10 s of IR light illumination.

FIG. 10 depicts the optical images of silicon pieces before and after “pick and release” procedures using CN9021/MWCNT1% and CN9021-PEGDA20/MWCNT1%.

FIG. 11 depicts the optical images of CN9021-PEGDA20-MWCNT1% (top row) and CN9021-PEGDA20 (bottom row) after laser illumination (488 nm).

FIG. 12 depicts the schematic of polymerization performed under open and closed conditions.

FIG. 13 depicts the tack forces of CN9021-PEGDA15 films prepared from polymerization under open and closed conditions.

### DESCRIPTION

It has been surprisingly found that the combination of a particular kind of crosslinked polymeric material with a photothermal agent allows for the generation of a photothermal adhesive with superior properties. In particular, it is noted that the presence of a material to generate crosslinks, by tuning the concentration of the crosslinks, the adhesive properties can be effectively tuned between 1.3-0.27 N/20 mm width. This allows for an object to be picked up. By controlling the concentration of the crosslinks in the adhesive, it is possible to ensure that minimal residues are deposited on an object that is picked up and then deposited in a desired position. As the adhesive has controllable adhesion at low force ranges, miniature objects (millimeter to micrometer scale) with low weights can be easily detached. The deposition of an object picked up by the adhesive may be accomplished by thermal expansion and/or adhesion. For example, when the photothermal agent generated heat when subjected to light (e.g. multiwalled carbon nanotubes (MWCNTs)), the heat generated from this illumination of the adhesive drives thermal expansion for release of an object bound to the adhesive. When laser sources are used, localized heat can be generated that leads to ablation of the adhesive for release. In such cases, a lower content of the photothermal agent (e.g. MWCNT) may be favorable for lower residue left on the deposited object.

Furthermore, a simple fabrication of the photothermal adhesive is also provided, which fabrication uses a simple blade-coating process that allows the photothermal adhesive to be manufactured in a scalable manner.

In a first aspect of the invention, there is provided a photothermal adhesive comprising:
a crosslinked polymeric matrix formed by the random block copolymerisation of:
   a urethane acrylate polymeric material that has two or more acrylate end groups; and
   a polymeric or oligomeric crosslinker material having two or more acrylate end groups; and
a photothermal agent, wherein the photothermal agent is dispersed within the crosslinked polymeric matrix.

In embodiments herein, the word “comprising” may be interpreted as requiring the features mentioned, but not limiting the presence of other features. Alternatively, the word “comprising” may also relate to the situation where only the components/features listed are intended to be present (e.g. the word “comprising” may be replaced by the phrases “consists of” or “consists essentially of”). It is explicitly contemplated that both the broader and narrower interpretations can be applied to all aspects and embodiments of the present invention. In other words, the word “comprising” and synonyms thereof may be replaced by the phrase “consisting of” or the phrase “consists essentially of” or synonyms thereof and vice versa.

The phrase, “consists essentially of” and its pseudonyms may be interpreted herein to refer to a material where minor impurities may be present. For example, the material may be greater than or equal to 90% pure, such as greater than 95% pure, such as greater than 97% pure, such as greater than 99% pure, such as greater than 99.9% pure, such as greater than 99.99% pure, such as greater than 99.999% pure, such as 100% pure.

As used herein, the singular forms “a,” “an,” and “the” include plural referents unless the context clearly dictates otherwise. Thus, for example, reference to “a composition” includes mixtures of two or more such compositions, and the like.

When used herein “acrylate end group” is intended to cover any acrylate group that may be feasibly used in such copolymerisation reactions. Examples of suitable acrylate groups include the acrylate group itself with no substituents or alkyl derivatives thereof, such as methyl methacrylate, ethyl methacrylate and the like.

For the avoidance of doubt, the urethane acrylate polymeric material that has two or more acrylate end groups and the polymeric or oligomeric crosslinker material having two or more acrylate end groups are not the same material. In particular embodiments that may be mentioned herein, the polymeric or oligomeric crosslinker material having two or more acrylate end groups is not a urethane acrylate material.

The photothermal adhesive is formed by the random block copolymerisation of a urethane acrylate polymeric material that has two or more acrylate end groups and a polymeric or oligomeric crosslinker material having two or more acrylate end groups. As will be appreciated, the exact structure(s) of the resulting copolymerised materials will depend on the number of acrylate end groups present. Without wishing to be bound by theory, in embodiments where both the urethane acrylate polymeric material and the polymeric or oligomeric crosslinker material have two acrylate end groups, it is believed that the resulting product may have one of more structures selected from formula Ia, Ib and Ic, where A represents the urethane acrylate polymeric material and B represents the polymeric or oligomeric crosslinker material.

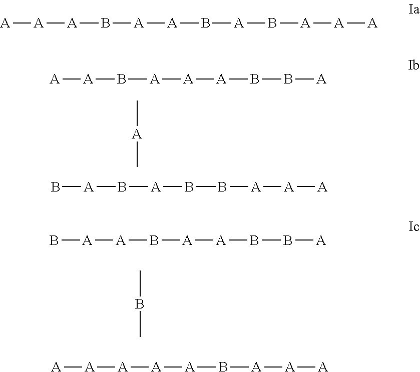

As will be appreciated, the formulae Ia to Ic are intended to illustrate the possible structures that may be obtained through the reaction of the urethane acrylate polymeric material that has two or more acrylate end groups with the polymeric or oligomeric crosslinker material having two or more acrylate end groups described above. This is because the reaction between these materials will be random and so there is no way to predict the exact combination of the components A and B (as defined above). Further, it will also be appreciated, that one or more of these structures may be present in the reaction product, which may therefore be described as a mixture comprising one or more of the suggested structures of formula Ia to Ic.

Finally, it will be appreciated that when one or both of the urethane acrylate polymeric and/or the polymeric or oligomeric crosslinker material have three or more acrylate (e.g. 3, 4 or 5) end groups the resulting copolymer, or polymeric network, mixtures can be derived by analogy to the above description of the situation where there are two acrylate groups on each component.

Any suitable urethane acrylate polymeric material may be used herein, provided that it provides the desired characteristics in the product disclosed herein.

Suitable urethane acrylate polymeric material that has two or more acrylate end groups may be a material that has a number average molecular weight of greater than 20,000 Daltons (e.g. from 20,001 to 50,000 Daltons).

Examples of suitable urethane acrylate polymeric material that has two or more acrylate end groups may include, but is not limited to an aliphatic acrylate polymeric material that has two acrylate end groups. Examples of the aliphatic acrylate polymeric material that has two acrylate end groups include, but are not limited to CN310, CN8881, CN8884, CN8888, CN9004, CN9014, CN9028, CN9031, CN9002, CN966J75, CN9018, CN9021, CN3108, CN3211, CN8004 and combinations thereof. In particular embodiments of the invention that may be mentioned herein, the urethane acrylate polymeric material that has two acrylate end groups may be CN9021.

As will be appreciated, the names provided above are tradenames used for the aliphatic acrylate polymeric materials that have two acrylate end groups. However, while it is believed that these materials have a common structure, represented below as formula II, the exact compositions of these materials are retained by the manufacturers as a trade secret.

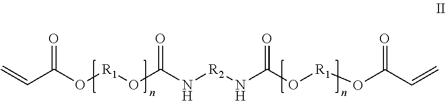

The—[O—R₁]ₙ— group above in formula II may be selected from polyols or polyacrylates. When used herein “n” is provided to indicate that this is a repeating unit. As a number of the aliphatic acrylate polymeric materials that may be used herein are commercial materials where the exact structure is only known to the manufacturer of said compounds, a specific numerical range for n is not explicitly stated herein.

Examples of suitable polyols that may be used in the above-mentioned materials include, but are not limited to polyethylene glycol and poly(propylene glycol). Examples of suitable polyacrylates that may be used in the above-mentioned materials include, but are not limited to, poly(2-hydroxyethyl methacrylate), poly(2-hydroxyethyl acrylate), and poly(2-hydroxybutyl acrylate). As will be appreciated, the terms “polyols” and “polyacylates” are used herein to refer to the polymeric materials that form part of the aliphatic acrylate polymeric materials disclosed herein. For the avoidance of doubt, the term “polyols” may be used herein to refer to polyethers, such as polyethylene glycol.

The R₂ group above in formula II may be selected from an isocyanate. Examples of suitable isocyanates that may be used in the above-mentioned materials include, but are not limited to hexamethylene diisocyanate (HDI), isophorone diisocyanate (IDI), bis(4-isocyanatocyclohecyl) methane (H₁₂ MDI), and 4,4′-methylenebis(phenyl isocyanate) (MDI). When used herein, the term “polymeric or oligomeric crosslinker material” herein may be intended to refer to a material that has a number average molecular weight of from 200 to 1,000 Daltons (e.g. of from 250 to 750 Daltons, such as from 400 to 600 Daltons, such as 575 Daltons).

The polymeric or oligomeric crosslinker material having two or more acrylate end groups may be any suitable material that can work in combination with the other components to provide the desired result. The polymeric or oligomeric crosslinker material having two or more acrylate end groups may be polar or non-polar. For example, the polymeric or oligomeric crosslinker material having two or more acrylate end groups may be selected from the group including, but not limited to 1,6-hexanediol diacrylate, tetra(ethylene glycol) diacrylate, or more particularly, poly(trimethylolpropane triacrylate-co-ethylene dimethacrylate), poly(ethyleneglycol) diacrylate (PEGDA), poly(caprolactone) dimethacrylate poly(propylene glycol) dimethacrylate, and combinations thereof. For example, in embodiments that may be mentioned herein the polymeric or oligomeric crosslinker material having two or more acrylate end groups may be poly(ethyleneglycol) diacrylate (PEGDA).

For the avoidance of doubt, the polymeric or oligomeric crosslinker material may be referred to herein as a polymeric material for the sake of brevity—even if the crosslinker material is itself only oligomeric in nature (e.g. less than 15 repeating units, such as less than or equal to 10 repeating units).

The polymeric or oligomeric crosslinker material having two or more acrylate end groups may be present in any suitable amount in the photothermal adhesive. For example, the polymeric or oligomeric crosslinker material having two or more acrylate end groups may be present in an amount of from 5 to 30 wt %, such as from 10 to 20 wt % relative to the total weight of the crosslinked polymeric matrix.

Without wishing to be bound by theory, it is believed that the concentration of crosslinks within the photothermal adhesive can be used to achieve a balance between adhesiveness and the amount of residue left on an objected that is picked up and placed by the adhesive. As noted below in the examples section, the peel force declined with an increasing amount of the polymeric or oligomeric crosslinker material within the final photothermal adhesive. Without wishing to be bound by theory, it is believed that these chemical crosslinks reduce the mobility of polymer chains, leading to a lack of hydrogen bonds and unbound low molecular weight polymer chains at the surface of the adhesive. In addition, the increase in stiffness with crosslinking reduces the ability of the film to conform to object surfaces, which in turn may reduce the contact area for adhesion, resulting in less residue being left on the object that is picked and placed. Hence it is believed that these opposing forces need to be tuned and balanced for optimal adhesion, good release properties and minimal residue on the object to be picked and placed.

Given the above, it is noted that too few crosslinks may cause the adhesive to have a very strong adhesion that does not allow for the release of an object that is to be picked and placed. Thus, the amount of the polymeric or oligomeric crosslinker material having two or more acrylate end groups needs to be controlled, and that this amount of the polymeric or oligomeric crosslinker material having two or more acrylate end groups may depend on the nature of the crosslinker material itself. Thus, in some embodiments, the minimum amount of the polymeric or oligomeric crosslinker material having two or more acrylate end groups may be 5 wt % relative to the total weight of the crosslinked polymeric matrix, while in other embodiments the minimum amount may be 10 wt %. Similarly, while having more of the polymeric or oligomeric crosslinker material having two or more acrylate end groups in the material is beneficial in allowing release of an object attached to the photothermal adhesive, too high an amount of the oligomeric crosslinker material having two or more acrylate end groups may result in a material that does not adhere and hold onto the desired object to be picked up. Again, this will be influenced by the nature of the oligomeric crosslinker material having two or more acrylate end groups being used in the photothermal adhesive. For example, in certain embodiments, the maximum amount of the polymeric or oligomeric crosslinker material having two or more acrylate end groups may be 20 wt % relative to the total weight of the crosslinked polymeric matrix, while in other embodiments the maximum amount may be 30 wt %.

For the avoidance of doubt, it is explicitly contemplated that where a number of numerical ranges related to the same feature are cited herein, that the end points for each range are intended to be combined in any order to provide further contemplated (and implicitly disclosed) ranges. Thus, the polymeric or oligomeric crosslinker material having two or more acrylate end groups may be present in an amount of:
from 5 to 10 wt %, from 5 to 20 wt %, from 5 to 30 wt %;
from 10 to 20 wt %, from 10 to 30 wt %; and
from 20 to 30 wt % relative to the total weight of the crosslinked polymeric matrix.

When used herein, the term “photothermal agent” is intended to refer to a material that can be activated by light and/or heat to cause release of an object bound to the photothermal adhesive. More particularly, the photothermal agent may be a material that is capable of absorbing light for heat generation to bring about adhesive release through thermal expansion and/or ablation. Examples of suitable photothermal agents include, but are not limited to, a UV-absorbing photothermal agent, and more particularly, a multiwalled carbon nanotube (MWCNT), a single walled carbon nanotube (SWCNT), an MXene, a graphite, a graphene oxide, a liquid metal, a carbon black, and combinations thereof. In particular embodiments that may be mentioned herein the photothermal agent may be 2-(2H-benzotriazol-2-yl)-4,6-ditertpentylphenol or, more particularly, a MWCNT.

The photothermal agent may be present in the photothermal adhesive in any suitable amount, provided that it can enable the release of an agent in response to a suitable stimulus (e.g. light and/or heat). For example, the photothermal agent may be present in the photothermal adhesive in an amount of from 0.1 to 10 wt % relative to the total weight of the photothermal adhesive, such as from 1 to 5 wt %.

The photothermal adhesive may be provided in any suitable form. For example, the photothermal adhesive may be provided in the form of a film.

As will be appreciated, the photothermal adhesive may be opaque or transparent (or in-between these extremes). Whether the photothermal adhesive is opaque or transparent may be affected by the type(s) of photothermal agent used. For example, if MWCNT is used, then the photothermal adhesive may be opaque (e.g. it may be black). However, if 2-(2H-benzotriazol-2-yl)-4,6-ditertpentylphenol is used, then the photothermal adhesive (particularly when presented as a film) may be transparent.

As mentioned above, the fabrication method for the manufacture of the photothermal adhesive is simple and scalable. Thus, in a further aspect of the invention there is provided a method of forming a photothermal adhesive as described hereinbefore, the method comprising the steps of:
(a) providing a mixture comprising:
   a urethane acrylate polymeric material that has two or more acrylate end groups; and
   a polymeric or oligomeric crosslinking material having two or more acrylate end groups;
   a photothermal agent; and
   a radical initiator;
(b) heating the mixture at a temperature of from 50 to 100° C. for a period of time to provide the photothermal adhesive.

The mixture provided in step (a) above may be obtained initially by mixing the components listed in a solvent and then removing the solvent. Any suitable solvent may be used, such as an organic solvent. A suitable solvent that may be mentioned in embodiments herein may be acetone.

For the avoidance of doubt, the urethane acrylate polymeric material that has two or more acrylate end groups, the polymeric or oligomeric crosslinking material having two or more acrylate end groups and the photothermal agent are as described above in relation to the photothermal adhesive itself and so description of these materials and their relative amounts will not be listed again for the sake of brevity.

The temperature for step (b) of the process may be any suitable temperature. For example, the temperature may be from 70 to 90° C. Any suitable period of time may be used herein. For example, the period of time may be from 15 minutes to 1 hour, such as from 30 to 45 minutes.

The polymerisation may occur in a vessel that is exposed to the ambient environment or in a vessel that is not exposed to the ambient environment. Thus, in certain embodiments of the invention, the polymerisation occurs in a vessel without exposure to the ambient atmospheric conditions. For example, the vessel may be an enclosed mould.

As noted hereinbefore, the photothermal adhesive disclosed herein may be used to pick up and deposit an object in a desired position.

Thus in a further aspect of the invention, there is provided a use of a photothermal adhesive as described herein in a pick and place operation of an object. The object may have any suitable size and shape that can be picked up after adhesion to the photothermal adhesive. For example, the object may be in the micrometer or millimetre scale.

In yet a further aspect of the invention, there is provided a method of picking and placing an object, the method comprising:
(i) adhering an object to be placed to a film of a photothermal adhesive, where the photothermal adhesive is as described herein to form an adhered object; and
(ii) placing the adhered object at a desired site and releasing the object from the film of photothermal adhesive by applying light from a light source to the film, thereby causing thermal expansion or ablation of the film to effect release of the adhered object.

As above, the object may have any suitable size and shape that can be picked up after adhesion to the photothermal adhesive. For example, the object may be in the micrometer or millimetre scale.

Any suitable light source may be used herein. Examples of suitable light sources may include, an IR laser light source or a UV laser light source.

When the light source is an IR laser light source it may have a wavelength of from 500 to 1,080 nm or a laser having a wavelength of less than 500 nm, such as 488 nm or such as 355 nm (e.g. 488 nm). In such embodiments, the photothermal agent may be preferably selected from the group including, but not limited to, a multiwalled carbon nanotube (MWCNT), a single walled carbon nanotube (SWCNT), an MXene, a graphite, a graphene oxide, a liquid metal, a carbon black, and combinations thereof.

As will be appreciated, a suitable level of pulse energy for the IR laser is required in such embodiments. For example, the IR laser light source may have a pulse energy of from greater than 0 to 500 μJ.

When the light source is an UV light source having a wavelength of from 10 to 400 nm or a laser having a wavelength of less than 400 nm, such as 200 nm. In such embodiments, the photothermal agent is preferably a UV-absorbing photothermal agent. Examples of UV-absorbing photothermal agents that may be mentioned herein include, but are not limited to, of 4-phenylazophenol and, more particularly, 2-(2H-benzotriazol-2-yl)-4,6-ditertpentylphenol.

As will be appreciated, a suitable level of pulse energy for the UV laser is required in such embodiments. For example, the UV laser light source may have a pulse energy of from greater than 0 to 500 μJ.

The following statements of invention are also disclosed herein.

1. A method of forming a photothermal adhesive, comprising
a. a first co-polymer which is an acrylate-based polymer, a second co-polymer which is a diacrylate-based polymer and a photothermal agent. The two co-polymers are chemically cross-linked with the photothermal agent dispersed within the crosslinked network;
b. providing a radical initiator to cross-link the first and second co-polymers;
c. curing the cross-linked co-polymers composites at 70-90° C. for a minimum of 30 minutes,
wherein:
   the second co-polymer may be poly(ethylene glycol) diacrylate (PEGDA), preferably with a molecular weight, Mₙ, of from 250 to 700;
   the photothermal agents may be multiwalled carbon nanotube (MWCNT), single walled carbon nanotube (SWCNT), MXene, graphite, graphene oxide, liquid metal, or carbon black;
   the mass ratio of the second co-polymer is about 5-30 wt %; and
   the mass ratio of the photothermal agent is about 0.1-10 wt %.

2. Chemical crosslinking performed from statement 1 to tune the adhesive performance.

3. Photothermal agents used in statement 1 to absorb light for heat generation that brings about adhesive release through thermal expansion.

4. Photothermal agents used in statement 1 to absorb light for heat generation that brings about adhesive release through ablation.

Advantages associated with the photothermal adhesives disclosed herein are discussed below, with reference to the non-limiting example of a photothermal adhesive formed using of CN9021 (as the urethane acrylate polymeric material), PEGDA (as the polymeric or oligomeric crosslinker material) and a photothermal agent (e.g. MWCNT) include, but are not limited to, the following.
The use of PEGDA to tune the adhesive properties of CN9021 allow miniature (millimeter to micrometer scale) objects to be easily released.
The presence of photothermal agents within CN9021—PEGDA to absorb light for heat generation. Heat generated can be used to induce thermal expansion or ablation.
Crosslinking CN9021 with PEGDA reduces residue deposition on object after adhesion release.

Further aspects and embodiments will now be discussed by reference to the following non-limiting examples.

### EXAMPLES

### Materials

CN9021 was purchased from Sartomer Company and used as received. Polyethylene glycol diacrylate (PEGDA), azobisisobutyronitrile (AIBN), 2-(2H-Benzotriazol-2-yl)-4,6-ditertpentylphenol (BZT) and acetone was purchased from Sigma Aldrich and used as received. Multiwalled carbon nanotubes (MWCNT) was purchased from Nanocyl with an average diameter of 9.5 nm and average length of 1.5 μm. Two-part epoxy (Gorilla Epoxy) was purchased from Gorilla Glue Company.

### Example 1. Synthesis of CN9021-PEGDA Photothermal Adhesive

First, CN9021, PEGDA, photothermal filler (MWCNT or BZT), and acetone were mixed. For polymer mixtures with MWCNT, probe sonication for 10 min at 100 W was performed to prevent aggregation of MWCNT. Polymer mixtures with BZT were mixed for 1 hour (h) at which all BZT powder would have dissolved. Similarly, polymer mixtures without photothermal fillers were mixed for 1 h. Acetone was then removed from the resultant mixtures using a rotary evaporator at 40° C. AIBN was then added and mixed with the resultant mixture. Subsequently, the resultant mixture was blade-coated on a glass plate and degassed to remove air bubbles that may lead to imperfections in adhesive elastomer. The coated mixture was placed on a hotplate at 80° C. for 2 h under inert conditions to allow free radical polymerization to take place, forming the photothermal adhesive elastomer. The feasibility of the following reaction is dependent on the presence of acrylate functional groups that allow addition reactions to take place in starting oligomers and monomers.

### Example 2. Adhesive Properties of CN9021-PEGDA Elastomer

To evaluate the adhesion properties of CN9021-PEGDA elastomer prepared in Example 1, 180° peel tests were performed.

### 180° Peel Tests

PET films were bonded to a steel plate with epoxy for mechanical support and clamped by the bottom grip of the tensile testing machine. Samples with a width of 20 mm were prepared with one end being clamped by the upper grip of the tensile testing machine. Subsequently, the free end of the sample was adhered to the PET films over the back to form a “U” shape. Peel tests were performed at a pulling rate of 300 mm/min, at which the samples peel at 180°.

### Results and Discussion

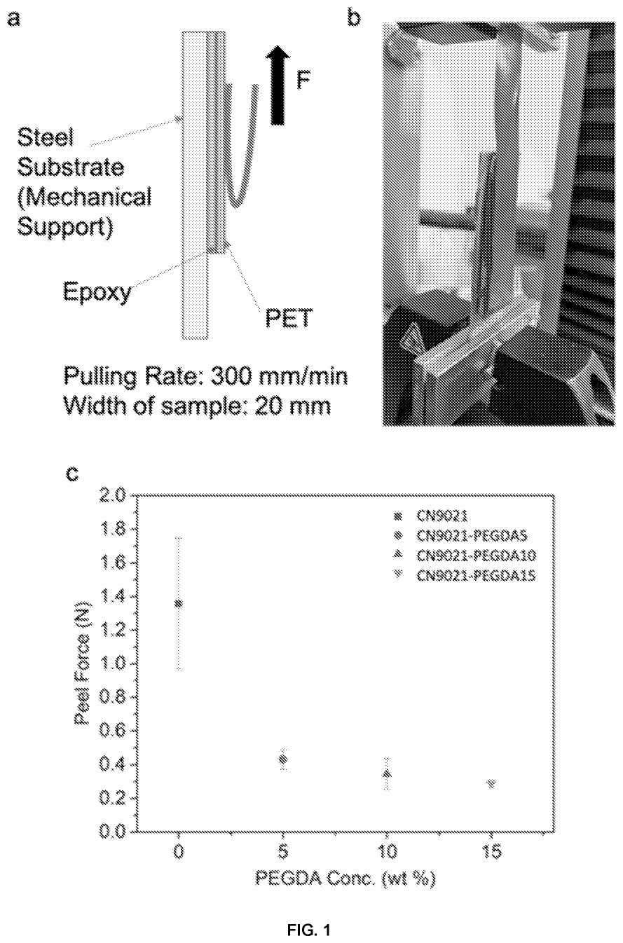

As shown in FIG. 1, the peel force declined with increasing PEGDA content. With these chemical crosslinks, the mobility of polymer chains is reduced, leading to a lack of hydrogen bonds at the surface of the film. In addition, the increase in stiffness with crosslinking reduces the ability of the film to conform to object surfaces and thus reduces the contact area for adhesion. As also shown in FIG. 1, by tuning the concentration of PEGDA crosslinks, the adhesive properties can be effectively tuned between 1.3-0.27 N/20 mm width.

### Example 3. Photothermal Properties CN9021-PEGDA/MWCNT Adhesives

To evaluate the photothermal effect, UV-VIS-NIR and IR light illumination measurements were conducted on CN9021-PEGDA15 (15 wt % of PEGDA) films with different loadings of MWCNT. The thermal stability and the residual amount were evaluated through TGA.

### Synthesis of CN9021-PEGDA15 (15 wt % of PEGDA)

CN9021 was mixed with 15 wt % of PEGDA. To ensure homogenous mixing, a solvent (acetone, isopropyl alcohol or ethanol) of equal weight to the mixture was added and stirred for 1 h. The solvent was subsequently removed with a rotary evaporator at 40° C. Next, 1 wt % of AIBN was added into the mixture and stirred. The mixture was blade-coated on a glass plate and cured at 80° C. for 2 h under inert conditions.

Synthesis of CN9021-PEGDA15 Films with Different Loadings of MWCNT

CN9021-PEGDA15/MWCNT elastomer composite was successfully fabricated through free radical polymerization using a radical initiator. CN9021 was mixed with 15 wt % of PEGDA and various loadings of MWCNT. To prevent the aggregation of MWCNT, acetone of equal weight to the polymer mixture was added and the reaction mixture underwent probe sonication for 10 min at 100 W. The solvent was subsequently removed with a rotary evaporator at 40° C. Next, 1 wt % of AIBN was added into the mixture and stirred. The mixture was blade-coated on a glass plate, degassed and cured at 80° C. for 2 h under inert conditions.

### Ultraviolet-Visible-Near Infrared (UV-VIS-NIR) Measurements

Absorbance measurement of samples were performed using UV-VIS-NIR Lambda 950 from 300 to 1100 nm.

### IR Light Illumination

Illumination measurements were performed by shining a light source (Phillips BR125) with a wavelength range of approximately 580 to 1080 nm onto samples (1×1 cm) for 120 s. Power intensities were controlled by adjusting the distance between the lamp source and the sample. The surface temperature was monitored using a thermal camera (Fluke Ti200) and its software.

### TGA

TGA measurements were performed at a heating rate of 10° C./min from 30 to 600° C. under nitrogen gas.

### Results and Discussion

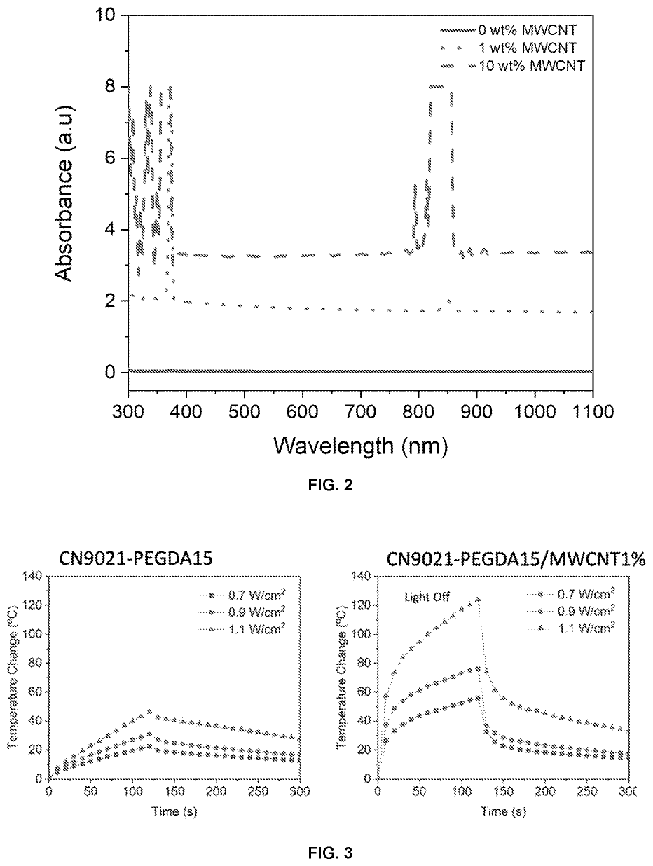

As expected, with the addition of MWCNT, absorption over the range of 300 to 1100 nm was increased (FIG. 2). However, at high amounts of MWCNT (10 wt %), increased scattering was observed, owing to the agglomeration of MWCNT. Despite this, a clear improvement to the absorption between 300 to 1100 nm was observed for all concentrations of MWCNT.

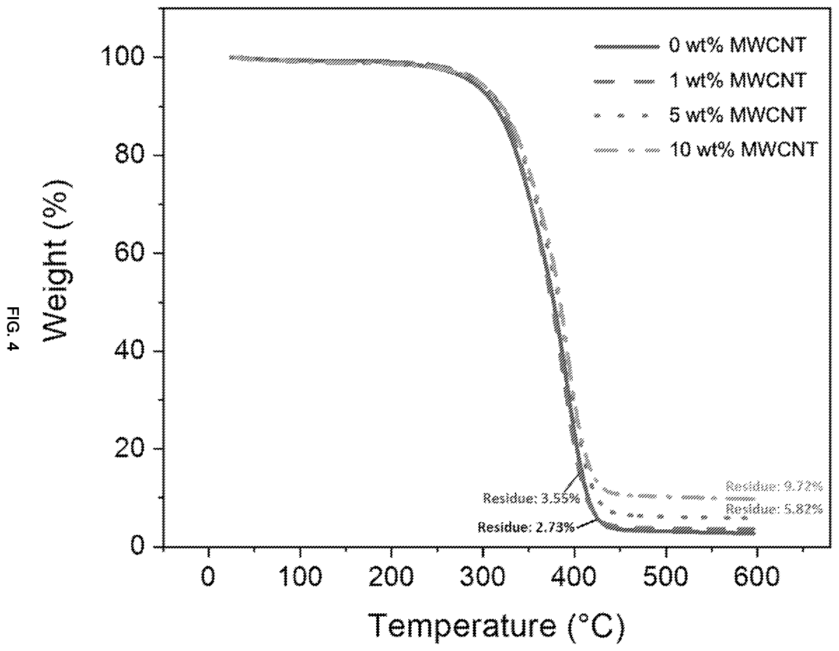

Photothermal effects of MWCNT were observed through illuminating CN9021-PEGDA15 and CN9021-PEGDA15/MWCNT1% with IR light (500 to 1080 nm) at different powers. As shown in FIG. 3, with a small amount of MWCNT (1 wt %), CN9021-PEGDA15/MWCNT1% films generated a temperature change of close to 130° C. at 1.1 W/cm², a stark contrast from CN9021 films that increased by only 50° C. under similar conditions. Furthermore, as expected, with increasing power, the maximum temperature changes generated rose accordingly.

The TGA analysis of CN9021-PEGDA15 with different concentrations of MWCNT (0, 1, 5, 10 wt %) is depicted in FIG. 4. Lower contents of MWCNT will be favorable for lower residues as shown from TGA (FIG. 4).

### Example 4. Photothermal Properties CN9021-PEGDA-BZT Adhesives

To evaluate the photothermal effect, UV-VIS-NIR AND UV illumination measurements were conducted on CN9021-PEGDA15 (15 wt % of PEGDA) films with different loadings of BZT. CN9021-PEGDA15 elastomer was prepared from 15 wt % of PEGDA by following the protocol in Example 3. UV-VIS-NIR measurements were performed by following the protocol in Example 3 except from 300 to 2500 nm.

Synthesis of CN9021-PEGDA15 Films with Different Loadings of BZT

CN9021-PEGDA15/BZT elastomer composite was successfully fabricated through free radical polymerization using a radical initiator. CN9021 was mixed with 15 wt % of PEGDA and various loadings of BZT. Acetone of equal weight to the polymer mixture was added and mixed for 1 h, at which BZT would be completely dissolved. The solvent was subsequently removed with a rotary evaporator at 40° C. Next, 1 wt % of AIBN was added into the mixture and stirred. The mixture was blade-coated on a glass plate, degassed and cured at 80° C. for 2 h under inert conditions.

### UV Light Illumination

Illumination measurements were performed by shining a UV light source with a wavelength range of approximately 395 nm onto samples (1×1 cm). Illumination was performed for 120 s at an intensity of 5000 μW cm⁻². The surface temperature was monitored using from a thermal camera (Fluke Ti200) and its software.

### Results and Discussion

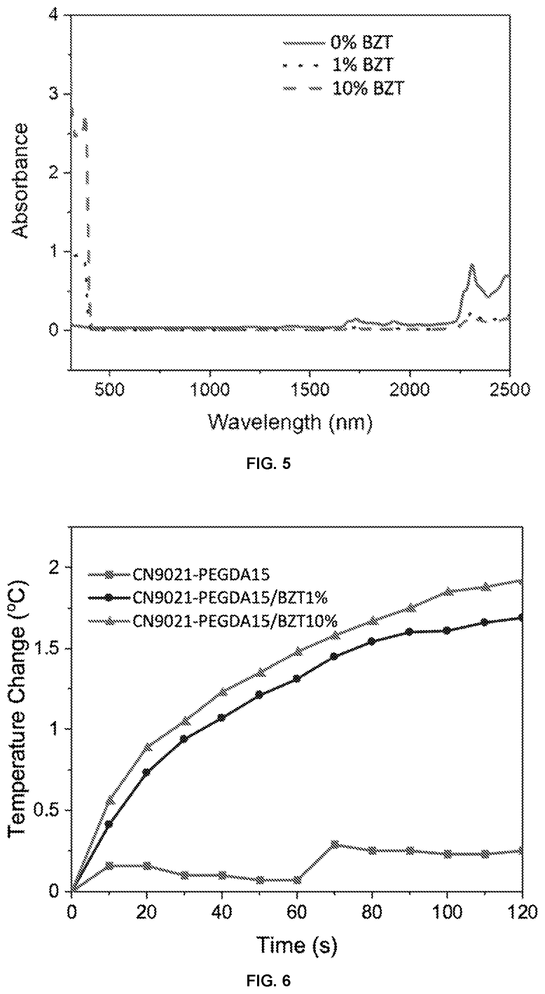

With increasing amount of BZT from 1 to 10 wt %, the film absorption within the UV wavelength range (300 to 380 nm) is enhanced accordingly (FIG. 5). In addition, the low absorbance within the visible light range (400 to 700 nm) indicates the transparent nature of the films. This transparency is particularly crucial for alignment procedures between the laser and millimeter-scale objects for release operations.

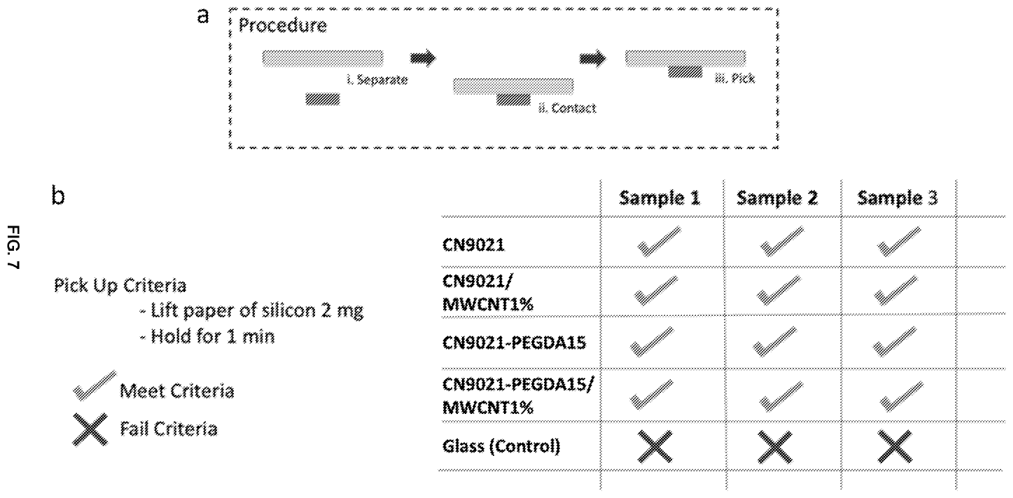

Photothermal effects of BZT were observed through illuminating CN9021-PEGDA15, CN9021-PEGDA15/BZT1% and CN9021-PEGDA15/BZT10% with a UV light (395 nm) for 120 s at an intensity of 5000 μW cm⁻². As shown in FIG. 6, films with BZT showed an increase in temperature while CN9021-PEGDA15 showed negligible change. CN9021-PEGDA15/BZT1% and CN9021-PEGDA15/BZT10% showed temperature increase of 1.70 and 1.92° C., respectively, after 120 s, indicating that the amount of heat generated from UV light exposure can be increased with BZT concentrations.

### Example 5. Pick and Place Operation of Millimeter Scale Objects

With controllable adhesion at low force ranges, miniature objects (millimeter to micrometer scale) with low weights can be easily detached. Furthermore, a simple fabrication of the elastomer composite was presented through a simple blade coating process (as described in Example 3) that allows the photothermal adhesive tape to be scalable. For example, with MWCNT acting as the photothermal agent, heat generated from the illumination of light can be used to drive thermal expansion for release.

With the elastomer composites prepared in the above examples, and CN9021-PEGDA20, photothermal adhesive tapes with switchable adhesion were designed. The photothermal adhesive tapes were taken for pick and place operation of millimeter scale objects.

### Pick and Place Operation

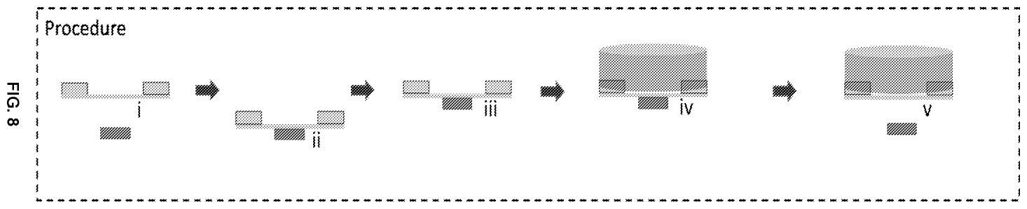

Adhesion capabilities for lifting the small objects were simulated using a piece of paper and silicon. To ensure that the adhesion was from the properties of the tape, glass slides were used as controls. Pick up procedures were performed by gently placing the tape on the target object before being lifted as shown in FIG. 7a. As depicted in FIG. 7a, there are steps:
(i) separate;
(ii) contact; and
(iii) pick.

The suitability of the tape was determined by a criterion of lifting the target object of at least 2 mg and maintaining its adhesion for a minute.

To release the object, IR light (500 to 1000 nm) were directly illuminated onto the tape (FIG. 8). As depicted in FIG. 8, there are steps:
(i) separate;
(ii) contact;
(iii) pick;
(iv) IR light irradiation with a power of 1.1 W cm²; and
(v) drop.

Within 10 s, silicone pieces were released from the tape. The release of the object was achieved as differential thermal expansion between the tape and the object results in a stress build up at the interface, causing delamination (R. Saeidpourazar et al., J. Microelectromechanical Syst. 2012, 21, 1049).

CN9021-PEGDA20 CN9021-PEGDA20 was prepared from 20 wt % of PEGDA by following the protocol for CN9021-PEGDA15 in Example 3.

### Results and Discussion

FIG. 7b depicts the suitability of the adhesive for pick up.

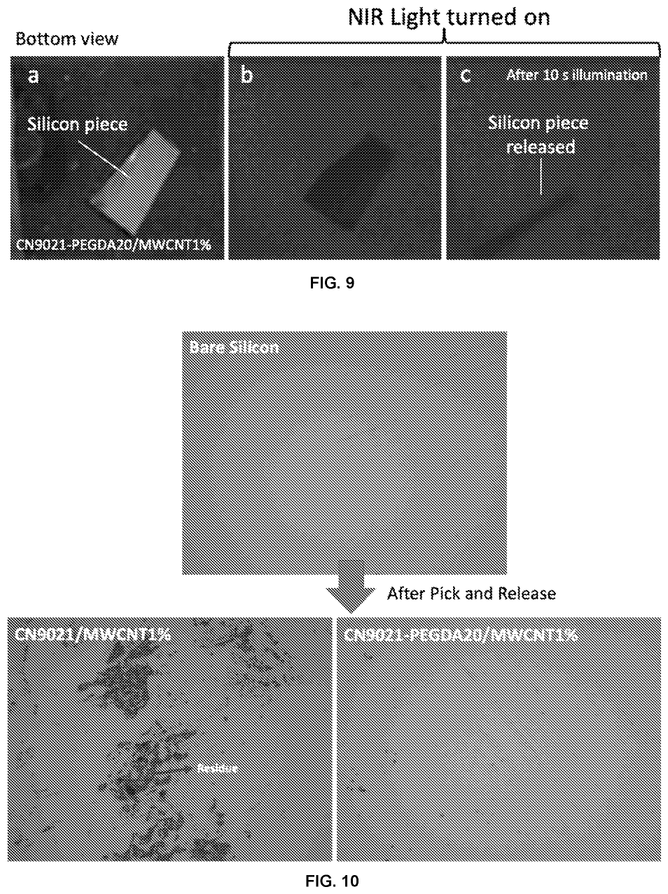

At low PEGDA crosslinks (0 to 10 wt %), the objects were unable to be released owing to strong adhesive force. In contrast, CN9021-PEGDA15 and CN9021-PEGDA20 had reduced adhesive properties that allowed the release of the object as the stress generation during thermal expansion was larger than its adhesive strength. This is observed in FIG. 9 that shows the digital images of a silicon object adhered to CN9021-PEGDA20/MWCNT. After 10 s of IR illumination, the silicon object was released.

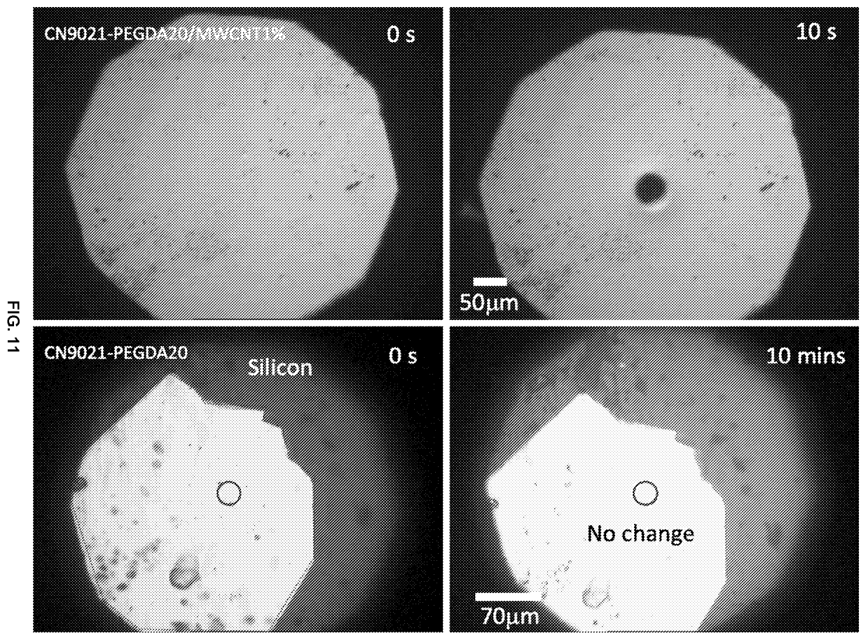

Based on this procedure, silicon pieces that were released from CN9021/MWCNT1% and CN9021-PEGDA20/MWCNT1% were analyzed for residues. Evident from the optical images, silicon pieces released from CN9021/MWCNT1% displayed higher residues on its surface (FIG. 10). This may be attributed to the larger amount of unbounded low molecular weight polymer chains at lower crosslinking densities. Hence, to avoid residues on the dies, adhesives with higher amounts of crosslinking would be favorable.

### Example 6. Laser Ablation of CN9021-PEGDA-MWCNT

Material ablation has often been a technique utilized in laser induced forward transfer for die release. When laser sources are used, localized heat can be generated that leads to ablation of the tape for release. Herein, the ability to ablate CN9021-PEGDA-MWCNT was evaluated with a laser source (488 nm).

### Laser Ablation Experiments

A laser source of 488 nm from confocal Raman spectroscopy equipment (Alpha300 SR, WITec) was illuminated onto the sample for 10 s. For CN9021-PEGDA20, the illumination time was extended to 10 min.

### Results and Discussion

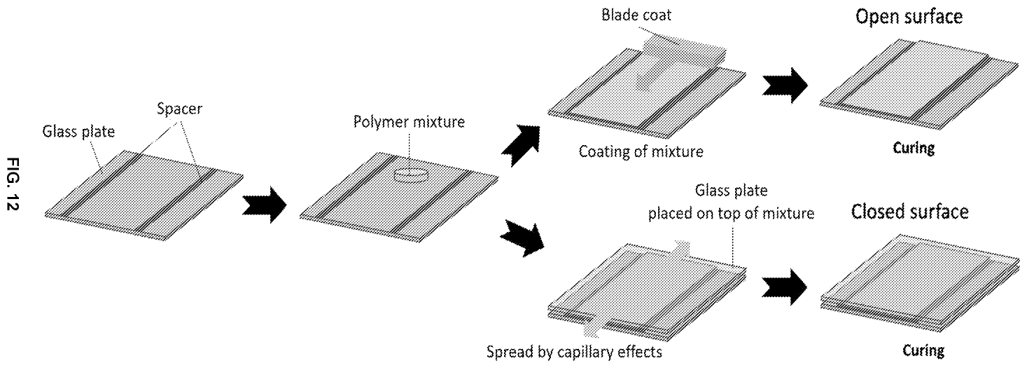

After illumination for 10 s, an ablation phenomenon is evident from the imaging of a burnt hole marked at the laser spot (FIG. 11). Unlike irradiations with IR light, the ablated regions (or burnt mark) could be attributed to the high temperatures from high localized temperatures generated. In contrast, no burnt holes were observed in CN9021-PEGDA20 adhesives even after laser illumination for 10 min. Therefore, ablation is only observed when MWCNT is present. This highlights the importance of the incorporation of photothermal agent to induce the ablation effect for “pick and release” procedures.

Therefore, in this disclosure, we have designed a photothermal adhesive tape that switch its adhesive state for pick and place operations. This is achieved through introducing photothermal agents that absorbs light for heat generation. Owing to the differential thermal expansion of the tape and the object picked up, the stress build-up leads to the delamination and release of the object. In addition, the interfacial strength and surface properties of the adhesive can be tuned based on the concentration of PEGDA crosslinkers. With these chemical crosslinks, the mobility of polymer chains and the amount of hydrogen bonds at the surface of the film can be adjusted. This expands the versatility of the photothermal adhesive tape where the adhesive strengths can be tuned accordingly to the object that undergoes pick and place operations.

### Example 7. Synthesis of CN9021-PEGDA Photothermal Adhesive Under Closed Conditions

First, CN9021, PEGDA, photothermal filler (MWCNT or BZT) and acetone were mixed. For polymer mixtures with MWCNT, probe sonication for 10 min at 100 W was performed to prevent aggregation of MWCNT. Polymer mixtures with BZT were mixed for 1 h at which all BZT powder would have dissolved. Similarly, polymer mixtures without photothermal fillers were mixed for 1 h. Acetone was then removed from the resultant mixtures using a rotary evaporator at 40° C. AIBN was then added and mixed with the resultant mixture.

The procedure for polymerization under closed conditions is depicted in FIG. 12. Spacers were placed on a glass plate to control the thickness of the film and the resultant polymer mixture above was poured between the spacers. The mixture was degassed, and a top glass plate was placed above, sandwiching the mixture between two glass plates. For easy removal of the top glass plate after polymerization, the surface in contact with the polymer can be attached with a Teflon sheet or undergo hydrophobic treatment through vapor deposition of 1H,1H,2H,2H-Perfluorodecyltriethoxysilane. Through capillary effects, the mixture would spread to fill the remaining space between the glass plates. After which, the mixture was placed on a hotplate at 80° C. for 2 h to allow free radical polymerization to take place, forming the photothermal adhesive elastomer.

### Example 8. Tackiness of CN9021-PEGDA Adhesives Polymerized Under Open and Closed Condition

The tackiness of the adhesives can be further tuned by controlling the polymerization conditions. To evaluate this, tack tests were performed on CN9021-PEGDA15 prepared through open and closed polymerization conditions. Open polymerization conditions refer to the protocol described in Example 1 while closed polymerization conditions refer to the protocol described in Example 7.

### Tack Tests

Tack tests were performed by bonding the bottom surface of a CN9021-PEGDA15 adhesive to a metal plate using epoxy. The metal plate was mounted onto the bottom gripper of a tensile machine. On the other hand, a probe (1 cm diameter) was mounted onto the top gripper of the tensile machine. The probe was lowered to impose a 5 N compression force on the top surface of the CN9021-PEGDA15 adhesive. After which, the probe was raised at a rate of 10 mm/min and the tack force was measured.

### Results and Discussion

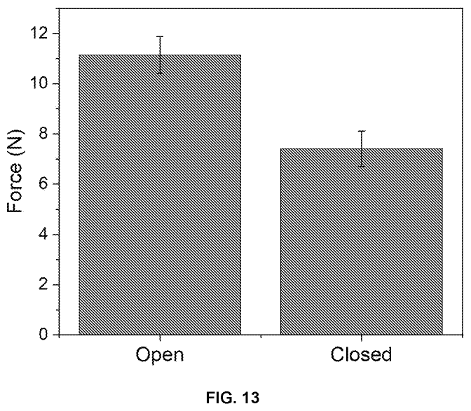

A lower tackiness (7.35 N tack force) was observed for CN9021-PEGDA15 that is polymerized under closed conditions (FIG. 13). By placing the top glass plate during polymerization, oxygen exposure is significantly removed, preventing oxygen inhibition effects on free radical polymerization. While polymerization under open conditions was performed under inert conditions, trace amount of oxygen is present at the surface, which causes a thin layer of oligomers that are not fully cured to be present, resulting in higher tackiness (11.2 N tack force). By applying this method, the tackiness of CN9021-PEGDA adhesives can be further tuned.

1. A photothermal adhesive comprising:
a crosslinked polymeric matrix formed by the random block copolymerisation of:
a urethane acrylate polymeric material that has two or more acrylate end groups; and
a polymeric or oligomeric crosslinker material having two or more acrylate end groups; and
a photothermal agent, wherein the photothermal agent is dispersed within the crosslinked polymeric matrix.

2. The photothermal adhesive according to claim 1, wherein the photothermal agent is capable of absorbing light for heat generation to bring about adhesive release through thermal expansion and/or ablation.

3. The photothermal adhesive according to claim 2, wherein the photothermal agent is selected from one of more of the group consisting of a UV-absorbing photothermal agent, and more particularly, a multiwalled carbon nanotube (MWCNT), a single walled carbon nanotube (SWCNT), an MXene, a graphite, a graphene oxide, a liquid metal, and a carbon black.

4. The photothermal adhesive according to claim 1, wherein the photothermal agent is present in the photothermal adhesive in an amount of from 0.1 to 10 wt % relative to the total weight of the photothermal adhesive.

5. The photothermal adhesive according to claim 1, wherein the urethane acrylate polymeric material that has two or more acrylate end groups is an aliphatic acrylate polymeric material that has two acrylate end groups.

6. The photothermal adhesive according to claim 5, wherein the aliphatic acrylate polymeric material that has two acrylate end groups is selected from one or more of CN310, CN8881, CN8884, CN8888, CN9004, CN9014, CN9028, CN9031, CN9002, CN966J75, CN9018, CN9021, CN3108, CN3211 and CN8004.

7. The photothermal adhesive according to claim 6, wherein the aliphatic acrylate polymeric material that has two acrylate end groups is CN9021.

8. The photothermal adhesive according to claim 1, wherein the urethane acrylate polymeric material that has two or more acrylate end groups has a number average molecular weight of greater than 20,000 Daltons, such as from 20,001 to 50,000 Daltons.

9. The photothermal adhesive according to claim 1, wherein the polymeric or oligomeric crosslinker material having two or more acrylate end groups is selected from one or more of 1,6-hexanediol diacrylate, tetra(ethylene glycol) diacrylate, or more particularly, poly(trimethylolpropane triacrylate-co-ethylene dimethacrylate), poly(ethyleneglycol) diacrylate (PEGDA), poly(caprolactone) dimethacrylate and poly(propylene glycol) dimethacrylate.

10. The photothermal adhesive according to claim 9, wherein the polymeric or oligomeric crosslinker material having two or more acrylate end groups is poly(ethyleneglycol) diacrylate (PEGDA).

11. The photothermal adhesive according to claim 1, wherein the polymeric or oligomeric crosslinker material having two or more acrylate end groups has a number average molecular weight of from 200 to 1,000 Daltons.

12. The photothermal adhesive according to claim 11, wherein the polymeric or oligomeric crosslinker material having two or more acrylate end groups has a number average molecular weight of from 250 to 750 Daltons, such as from 400 to 600 Daltons.

13. The photothermal adhesive according to claim 1, wherein the polymeric or oligomeric crosslinker material having two or more acrylate end groups is present in an amount of from 5 to 30 wt % relative to the total weight of the crosslinked polymeric matrix.

14. The photothermal adhesive according to claim 1, wherein the photothermal adhesive is provided in the form of a film and/or the photothermal adhesive is transparent.

15. A method of forming a photothermal adhesive according to claim 1, the method comprising the steps of:
(a) providing a mixture comprising:
a urethane acrylate polymeric material that has two or more acrylate end groups;
a polymeric or oligomeric crosslinker material having two or more acrylate end groups;
a photothermal agent; and
a radical initiator; and
(b) heating the mixture at a temperature of from 50 to 100° C. for a period of time to provide the photothermal adhesive.

16. (canceled)

17. The method according to claim 15, wherein the polymerisation occurs in a vessel without exposure to the ambient atmospheric conditions.

18. (canceled)

19. A method of picking and placing an object, the method comprising:
(i) adhering an object to be placed to a film of a photothermal adhesive, where the photothermal adhesive is as described in claim 1 to form an adhered object; and
(ii) placing the adhered object at a desired site and releasing the object from the film of photothermal adhesive by applying light from a light source to the film, thereby causing thermal expansion or ablation of the film to effect release of the adhered object.

20. The method according to claim 19, wherein the light source is an IR laser light source having a wavelength of from 500 to 1,080 nm or a laser having a wavelength of less than 500 nm, provided that the photothermal agent is selected from one of more of the group consisting of a multiwalled carbon nanotube (MWCNT), a single walled carbon nanotube (SWCNT), an MXene, a graphite, a graphene oxide, a liquid metal, and a carbon black.

21. The method according to claim 20, wherein the IR laser light source having a wavelength of from 500 to 1,080 nm or the laser having a wavelength of less than 500 nm has a pulse energy of from greater than 0 to 500 μJ.

22. The method according to claim 19, wherein the light source is an UV light source having a wavelength of from 10 to 400 nm or a laser having a wavelength of less than 400 nm, provided that the photothermal agent is a UV-absorbing photothermal agent.

23. (canceled)
